(19) United States
(12) Patent Application Publication
(10) Pub. No.: US 2026/0046365 A1
(43) Pub. Date: Feb. 12, 2026

(54) IMAGE FORMING APPARATUS

(71) Applicant: CANON KABUSHIKI KAISHA, Tokyo (JP)

(72) Inventor: YASUHIRO KOZUKA, Tokyo (JP)

(21) Appl. No.: 19/290,453

(22) Filed: Aug. 5, 2025

(30) Foreign Application Priority Data
Aug. 9, 2024 (JP) 2024-134365

(51) Int. Cl. H04N 1/00

(52) U.S. Cl. CPC H04N 1/00042; H04N 1/00888; H04N 1/00899

(57) ABSTRACT

An image forming apparatus includes a semiconductor device including a monitor terminal configured to monitor a voltage of a connected node which is connected to the monitor terminal, an image forming unit configured to form an image on a recording medium based on image data, and a controller configured to control the semiconductor device and the image forming unit, wherein the controller is configured to transmit a reset signal for resetting the semiconductor device to the semiconductor device.

### BACKGROUND

### Field of the Technology

The present disclosure relates to an image forming apparatus.

### Description of the Related Art

An image forming apparatus includes a circuit board for controlling operations of components located in the image forming apparatus. The circuit board has control functions for components which perform, for example, image processing and sheet conveyance processing. Electronic parts which constitute logic circuits, drive circuits, power supply circuits, etc., are mounted on the circuit board according to required functions.

US 2024/0105643 discloses a configuration in which electronic components (ICs: integrated circuits) with an error detection function, which notifies that an output voltage having a predetermined voltage value cannot be output due to reasons such as overcurrent, are implemented, and a configuration in which electronic components without the error detection function are implemented. In a case where the implemented electronic components have no error detection function, US 2024/0105643 proposes detecting a drop in output voltage using an externally located reset IC, etc.

Since the externally located reset IC is provided in a case where there is no error detection function, problems such as an increased number of parts, increased costs, and larger circuit boards are arising.

### SUMMARY

An image forming apparatus according to at least one embodiment of the present disclosure includes a semiconductor device including a monitor terminal configured to monitor a voltage of a connected node which is connected to the monitor terminal, an image forming unit configured to form an image on a recording medium based on image data, and a controller configured to control the semiconductor device and the image forming unit, wherein the controller is configured to transmit a reset signal for resetting the semiconductor device to the semiconductor device.

Features of the present disclosure will become apparent from the following description of embodiments with reference to the attached drawings. The following description of embodiments is described by way of example.

### BRIEF DESCRIPTION OF THE DRAWINGS

FIG. 1 is a simplified configuration diagram of a system.

FIG. 2 is a configuration diagram of an image forming apparatus.

FIG. 3 is a configuration diagram of a control unit.

FIG. 4 is a diagram of a semiconductor device with a manual reset function.

FIGS. 5A and 5B are diagrams of the semiconductor device without the manual reset function.

FIG. 6 is another diagram of the semiconductor device without the manual reset function.

FIG. 7 is an explanatory diagram of a circuit board on which semiconductor devices for multiple types of power supply monitoring devices are mountable.

FIG. 8 is an explanatory view of wiring patterns of the circuit board.

### DESCRIPTION OF THE EMBODIMENTS

Now, description of at least one embodiment of the present disclosure with reference to the accompanying drawings is given. A configuration and a circuit of an apparatus described in the at least one embodiment are mere examples, and the present disclosure is not limited to the contents described herein. In the at least one embodiment, description is given with an image forming apparatus as an example of electronic equipment, however, the at least one embodiment can be applied to an information processing apparatus such as a personal computer, or general electrical equipment such as an air conditioner or a refrigerator.

### System

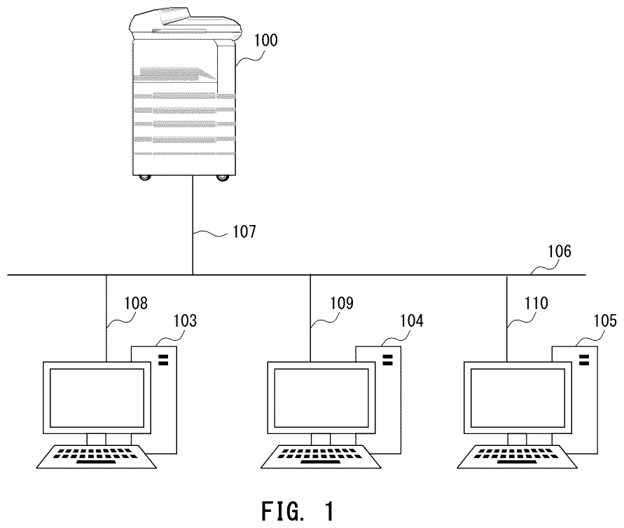

FIG. 1 is a simplified configuration diagram of a system including an image forming apparatus and an image processing controller. The system is configured so that an image forming apparatus 100 and personal computers (hereinafter referred to as “PC”) 103, 104, and 105 are interconnected and capable of communicating with each other via a network 106. The network 106 is a Local Area Network (LAN), a Wide Area Network (WAN), a public communication line, or the like. The PCs 103, 104, and 105 serve as image-processing controllers.

The image forming apparatus 100 is connected to the network 106 via a network cable 107. A plurality of image forming apparatus 100 may be connected to the network 106. The PCs 103, 104, and 105 are connected to the network 106 via a network cable 108, 109, and 110, respectively. FIG. 1 shows an example of a wired connection using network cables 107 to 110, however, the image forming apparatus 100 and the PCs 103, 104, and 105 may be wirelessly connected to the network 106.

Each of the PCs 103, 104, and 105 can transmit a print job to the image forming apparatus 100 through the network 106, respectively. Each of the PCs 103, 104, and 105 can send a remote shutdown instruction via the network 106 to shut down the power supply of the image forming apparatus 100.

### Image Forming Apparatus

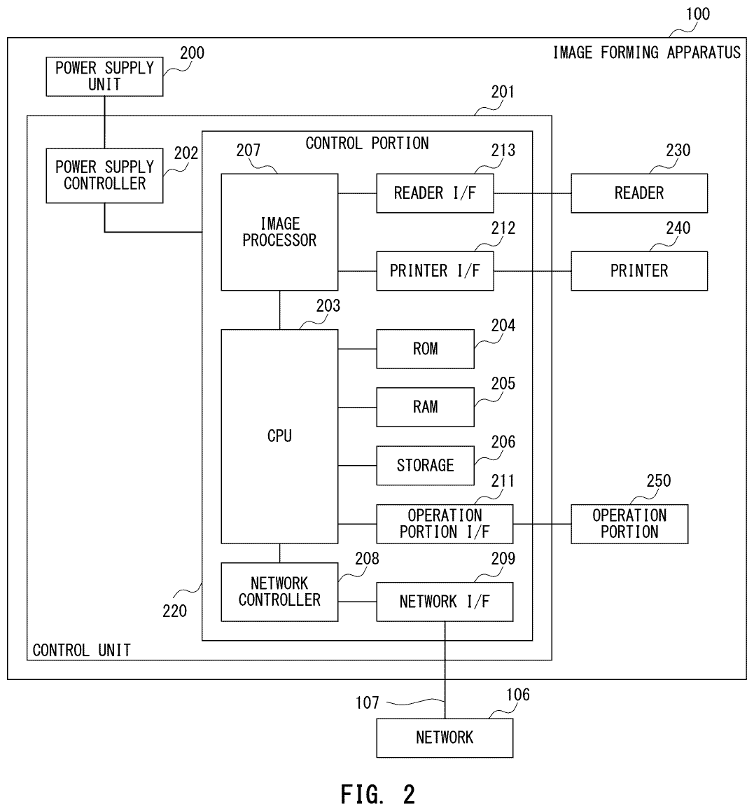

FIG. 2 is a configuration diagram of the image forming apparatus 100. The image forming apparatus 100 includes a power supply unit 200, a control unit 201, a reader 230, a printer 240, and an operation portion 250. The control unit 201 includes a power supply controller 202, which serves as a power supply control portion, and a control portion 220. The power supply controller 202 is connected to the power supply unit 200. The control portion 220 is connected to the power supply unit 200, the reader 230, the printer 240, and the operation portion 250. The control portion 220 is connected to the network 106 via the network cable 107.

The power supply unit 200 supplies power to each portion included in the image forming apparatus 100. The power supply controller 202 controls the supply of the power to the power supply unit 200 and the control portion 220. The power supply controller 202 is mounted to the control unit 201, and controls the supply of the power to each portion based on instructions from a user by a power switch etc. Details of the power supply controller 202 are described later.

The control portion 220 is an information processing apparatus having a Central Processing Unit (CPU) 203, a Read Only Memory (ROM) 204, Random Access Memory (RAM) 205, and a storage 206. The control portion 220 also includes an image processor 207, which serves as an image processing unit, and a network controller 208. Further, the control portion 220 includes an operation portion I/F 211, a printer I/F 212, a reader I/F 213, and a network I/F 209 as interfaces.

The CPU 203 controls the overall operation of the image forming apparatus 100 by executing computer programs such as a startup program stored in the ROM 204 and a control program stored in the storage 206. The RAM 205 provides a work memory for the CPU 203 to execute a computer program. The ROM 204 stores, in addition to the startup program, various setting values and the like.

The storage 206 is a large-capacity storage device, such as a hard disk drive (HDD) or a solid state drive (SSD). The storage 206 stores control programs and is used for storing temporary image data, etc. The storage 206 is connected to the CPU 203 via a predetermined interface such as serial ATA. CPU 203 writes and reads data from the storage 206. Multiple storages 206 may be connected to CPU 203. For example, the storage 206 may be configured using RAID 0 (striping) or RAID 1 (mirroring).

The image processor 207 is connected to the reader 230 via the reader I/F 213, and is connected to the printer 240 via the printer I/F 212. The reader 230 reads an image from an original and generate image data. The reader 230 includes an automatic document feeder (ADF) and a scanner unit, and reads an image from an original placed on a platen or the ADF to generate the image data. The printer 240 is an image forming unit which serves as an image former and forms an image on recording media, such as a sheet, based on the image data. Operations of the reader 230 and the printer 240 are controlled directly by CPU 203, or controlled by CPU 203 via the image processor 207.

The image processor 207 acquires image data from the reader 20, and performs signal processing such as color space conversion on the acquired image data to convert it into image data for printing. The image processor 207 transmits the image data for printing to the printer 240. The image processing of the image data may be performed by the reader 230 side. In addition, the image processor 207 may acquire the image data together with print jobs from the PCs 103 to 105 via the network 106 and perform predetermined image processing on the image data to generate the image data for the printer.

The network controller 208 communicates with the PCs 103 to 105 via the network I/F 209 and the network 106 under the control of the CPU 203. The network I/F 209 is a communication interface to communicate with the network 106.

The control portion 220 (CPU 203) is connected to the operation portion 250 via the operation portion I/F 211. The operation portion I/F 211 is a communication interface to communicate with the operation portion 250. The operation portion 250 is a user interface having an input interface and an output interface. Examples of the input interface include various key buttons and a touch panel. The user can input instructions etc., into the control portion 220 through the operation portion I/F 211 using the input interface. The output interface is a display, a speaker, and the like. The control portion 220 can display a setting screen and notify the user of the status of the image forming apparatus 100 via the output interface through the operation portion I/F 211.

### Power Supply Controller

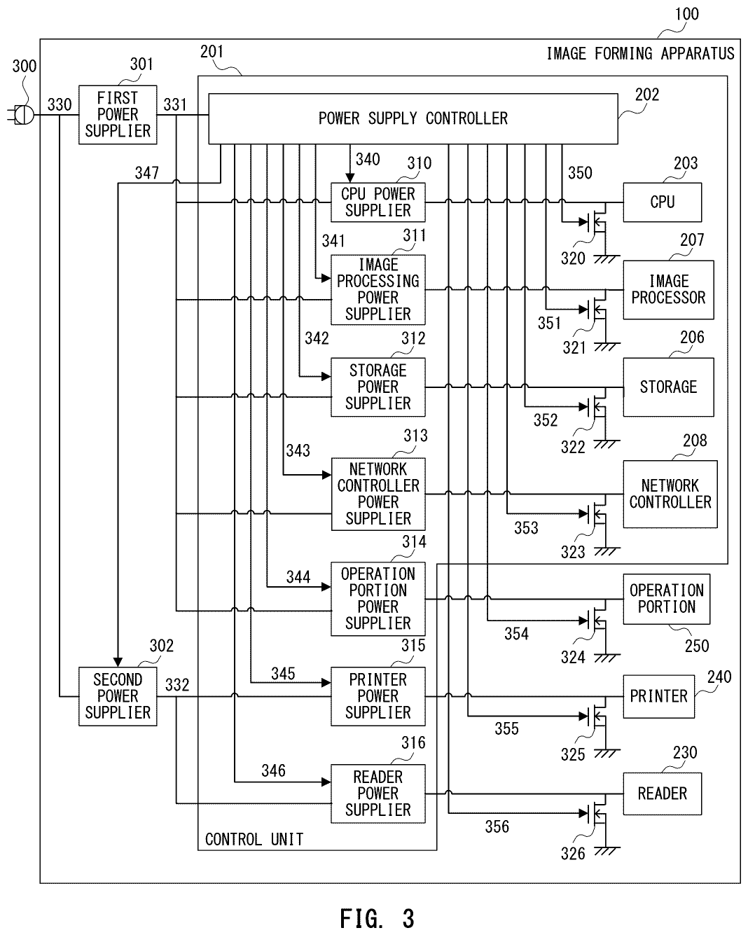

FIG. 3 is an explanatory diagram of the control portion 220. The power supply unit 200 includes a first power supplier 301 and a second power supplier 302. The control portion 220 includes a CPU power supplier 310, an image processing power supplier 311, a storage power supplier 312, a network controller power supplier 313, an operation portion power supplier 314, a printer power supplier 315, and a reader power supplier 316.

The first power supplier 301 and the second power supplier 302 are supplied with commercial power 330 from a power outlet 300. The first power supplier 301 provides first power 331, which is generated by converting the commercial power 330, to each of the power supply controller 202, the CPU power supplier 310, the image processing power supplier 311, the storage power supplier 312, the network controller power supplier 313, and the operation portion power supplier 314. The second power supplier 302 provides second power 332, which is generated by converting the commercial power 330, to each of the printer power supplier 315 and the reader power supplier 316.

The first power 331 supplied by the first power supplier 301 is converted to a voltage value corresponding to a supply destination. In other words, the voltage value of the first power 331 represents a value corresponding to each of the power supply controller 202, the CPU power supplier 310, the image processing power supplier 311, the storage power supplier 312, the network controller power supplier 313, and the operation portion power supplier 314. In other words, the first power 331 does not represent a single power, but represents a plurality of power having voltage values corresponding to the supply destinations. The first power supplier 301 outputs the first power 331 under the control of the power supply controller 202.

The power supply controller 202 outputs power control signals 340-344 for activating the operations of the CPU power supplier 310, the image processing power supplier 311, the storage power supplier 312, the network controller power supplier 313, and the operation portion power supplier 314. The CPU power supplier 310, the image processing power supplier 311, the storage power supplier 312, the network controller power supplier 313, and the operation portion power supplier 314 are activated by the corresponding power supply control signals 340-344, respectively.

The CPU power supplier 310 receives the power supply control signal 340 from the power supply controller 202. Based on the power supply control signal 340, the CPU power supplier 310 supplies the power to the CPU 203. A charge extraction portion 320 is connected to a wiring line for supplying the power from the CPU power supplier 310 to the CPU 203. The operation of the charge extraction portion 320 is controlled by a control signal 350 input from the power supply controller 202. The charge extraction portion 320 adjusts, when it is activated, the current value of the current flowing through a path through which the power is supplied from the CPU power supplier 310 to the CPU 203. The CPU 203 operates by receiving the power supplied from the CPU power supplier 310.

The image processing power supplier 311 supplies the power to the image processor 207 by activating the operation of the same by a power supply control signal 341. A charge extraction portion 321 is provided in a path for supplying the power from the image processing power supplier 311 to the image processor 207. The operation of the charge extraction portion 321 is controlled by a control signal 351 input from the power supply controller 202. The charge extraction portion 320 adjusts, when it is activated, the current value of the current flowing through a path through which the power is supplied from the image processing power supplier 311 to the image processor 207. The image processor 207 operates by receiving the power supplied from the image processing power supplier 311.

The storage power supplier 312 supplies the power to the storage 206 by activating the operation of the same by a power supply control signal 342. A charge extraction portion 322 is provided in a path for supplying the power from the storage power supplier 312 to the storage 206. The operation of the charge extraction portion 322 is controlled by a control signal 352 input from the power supply controller 202. The charge extraction portion 322 adjusts, when it is activated, the current value of the current flowing through a path through which the power is supplied from the storage power supplier 312 to the storage 206. The storage 206 operates by receiving the power supplied from the storage power supplier 312.

The network controller power supplier 313 supplies the power to the network controller 208 by activating the operation of the same by a power supply control signal 343. A charge extraction portion 323 is provided in a path for supplying the power from the network controller power supplier 313 to the network controller 208. The operation of the charge extraction portion 323 is controlled by a control signal 353 input from the power supply controller 202. The charge extraction portion 323 adjusts, when it is activated, the current value of the current flowing through a path through which the power is supplied from the network controller power supplier 313 to the network controller 208. The network controller 208 operates by receiving the power from the network controller power supplier 313.

The operation portion power supplier 314 supplies the power to the operation portion 250 by activating the operation of the same by a power supply control signal 344. A charge extraction portion 324 is provided in a path for supplying the power from the operation portion power supplier 314 to the operation portion 250. The operation of the charge extraction portion 324 is controlled by a control signal 354 input from the power supply controller 202. The charge extraction portion 324 adjusts, when it is activated, the current value of the current flowing through a path through which the power is supplied from the operation portion power supplier 314 to the operation portion 250. The operation portion 250 operates by receiving the power supplied from the operation portion power supplier 314.

Thus, the supply of the power to each portion is controlled by the power supply control signals 341-344 and the control signals 350-354 which are output from the power supply controller 202. The voltage value of the power may be set by the CPU power supplier 310, the image processing power supplier 311, the storage power supplier 312, the network controller power supplier 313, and the operation portion power supplier 314. For example, the voltage value of the first power 331 is kept constant and, in each of the CPU power supplier 310, the image processing power supplier 311, the storage power supplier 312, the network controller power supplier 313, and the operation portion power supplier 314, a voltage value corresponding to the subsequent components may be generated and supplied to the subsequent components.

The second power 332 supplied by the second power supplier 302 is converted to a voltage value corresponding to a supply destination. That is, the voltage value of the second power 332 is a value corresponding to each of the printer 240 and the reader 230. The printer 240 and the reader 230 have a large power load and consume a large amount of power. For this reason, the second power supplier 302 is provided separately from the first power supplier 301, and outputs the second power 332 only when necessary under the control of the power supply controller 202. The power supply controller 202 controls, by inputting a power control signal 347 to the second power supplier 302, the output of the second power 332 by the second power supplier 302.

The power supply controller 202 outputs power supply control signals 345 and 346, in order to activate the operation of the printer power supplier 315 and the reader power supplier 316. The printer power supplier 315 and the reader power supplier 316 can be operated by the corresponding power supply control signals 345 and 346, respectively.

The printer power supplier 315 supplies power to the printer 240 by activating the operation of the same by the power supply control signal 345. A charge extraction portion 325 is provided in a path for supplying the power from the printer power supplier 315 to the printer 240. The operation of the charge extraction portion 325 is controlled by a control signal 355 input from the power supply controller 202. The charge extraction portion 325 adjusts, when it is activated, the current value of the current flowing through a path through which the power is supplied from the printer power supplier 315 to the printer 240. The printer 240 operates by receiving the power supplied from the printer power supplier 315.

The reader power supplier 316 supplies the power to the reader 230 by activating the operation of the same by a power supply control signal 346. A charge extraction portion 326 is provided in a path for supplying the power from the reader power supplier 316 to the reader 230. The operation of the charge extraction portion 326 is controlled by a control signal 356 input from the power supply controller 202. The charge extraction portion 326 adjusts, when it is activated, the current value of the current flowing through a path through which the power is supplied from the reader power supplier 316 to the reader 230. The reader 230 operates by receiving the power supplied from the reader power supplier 316.

As shown in FIG. 3, the control unit 201 includes a plurality of components (the power supply controller 202, the power supplier 310-316). Each component is composed of a large number of electronic parts mounted on a circuit board. Each circuit board is used for power generation and power supply switching according to a specification of the image forming apparatus 100 on which it is mounted. Each component may be configured as a separate circuit board. Alternatively, multiple components may be mounted on a single circuit board.

Although the at least one embodiment is explained using the image forming apparatus 100 as an example, however, the at least one embodiment can be applied to any electronic apparatus that operates with a circuit board mounted thereon. Such electronic apparatus includes, for example, information processing devices such as personal computers and servers, and electrical appliances such as air conditioners and refrigerators. In the electronic apparatus, a power supply monitoring apparatus for monitoring the power level (e.g., voltage value and current value) may be mounted to maintain the power supply sequence to each part. Generally, in a power supply monitoring apparatus, a circuit board on which electronic components such as semiconductor devices are mounted is used.

### Semiconductor Device for Power Supply Monitoring Apparatus With Manual Reset Function

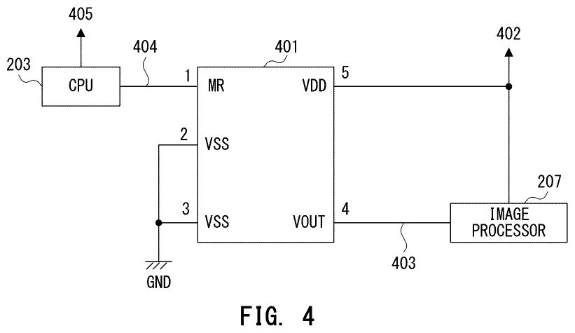

FIG. 4 is an explanatory diagram of a semiconductor device that is an electronic component for power supply monitoring apparatus with a manual reset function. The semiconductor device 401 includes an MR terminal, a VSS terminal, a VDD terminal, and a VOUT terminal. The semiconductor device 401 monitors power 402 supplied from the image processing power supplier 311 to the image processor 207. The VSS terminal is grounded.

The VDD terminal is a power supply terminal of the semiconductor device 401. The VOUT terminal is an output terminal for a reset signal 403 to the image processor 207. The semiconductor device 401 monitors the voltage value of the power 402 supplied from the VDD terminal. In a case where the voltage value is equal to or higher than a predetermined voltage, the semiconductor device 401 transmits a reset signal 403 with a predetermined logic value (in this case, a high level) from the VOUT terminal to the image processor 207. In a case where the voltage value is less than the predetermined voltage, the semiconductor device 401 transmits a reset signal 403 with a logic value opposite to that when the voltage value is equal to or greater than the predetermined voltage (in this case, a low level) from the VOUT terminal to the image processor 207. The determination of whether or not the voltage value is equal to or greater than the predetermined value is made, for example, based on the result of comparing the predetermined value with the voltage value of the power 402. The operation of the image processor 207 is reset in a case where a low-level reset signal 403 is input.

An MR terminal is a terminal to which the manual reset signal 404 is input from the CPU 203. The manual reset signal 404 is a signal to forcibly set the reset signal 403 to a low level irrespective of a state of the power 402 to be monitored. The manual reset signal 404 in FIG. 4 is issued, for example, in a case where the CPU 203 detects an operation abnormality of the image processor 207, and is used for the purpose of restarting (resetting) the image processor 207. The CPU 203 operates by receiving power 405 supplied from the CPU power supplier 310. In this way, the semiconductor device can be reset, with a simple circuit configuration, by inputting the manual reset signal 404 from the CPU 203 to the MR terminal.

### Semiconductor Device for Power Supply Monitoring Apparatus Without a Manual Reset Function

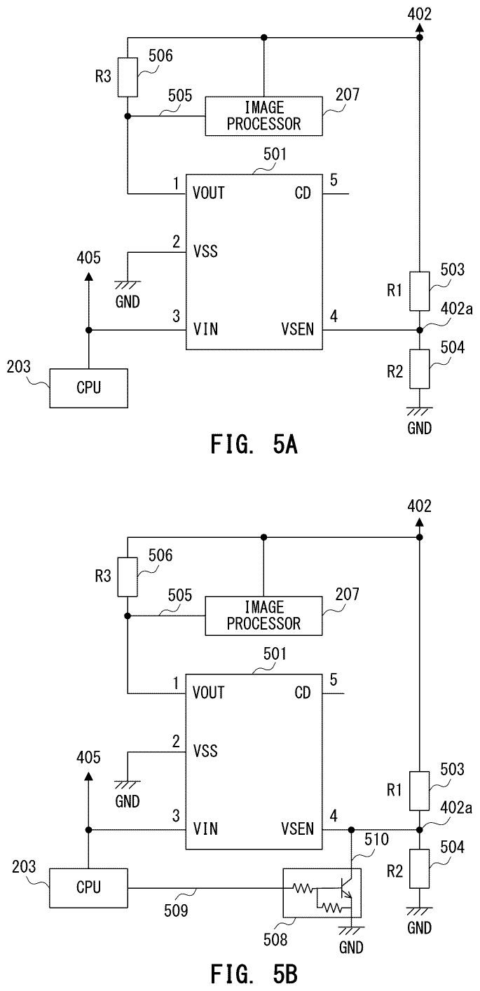

FIGS. 5A and 5B are explanatory diagrams of a semiconductor device for a power supply monitoring apparatus without the manual reset function. The manual reset function is not achieved by the semiconductor device 501 in the example of FIG. 5A. The manual reset function is achieved by peripheral components of the semiconductor device 501 in the example of FIG. 5B.

The semiconductor device 501 includes a VOUT terminal, a VSS terminal, a VIN terminal, a VSEN terminal, and a CD terminal. The VSS terminal is grounded. The VIN terminal is a power supply terminal of the semiconductor device 501. In the at least one embodiment, the power 405, which is supplied to the CPU 203 from the CPU power supplier 310, is also supplied to the VIN terminal.

The VSEN terminal is a monitor terminal for power monitoring to monitor the voltage of the connected node. In the at least one embodiment, the semiconductor device 501 monitors the power 402 supplied to the image processor 207 based on the power input from the VSEN terminal. The power 402 is divided by resistors 503 and 504. Divided power 402a is input to the VSEN terminal. The semiconductor device 501 determines whether the voltage value of the power 402a is equal to or greater than a predetermined voltage by comparing the voltage value of the divided power 402a input from the VSEN terminal with a predetermined value.

The VOUT terminal is a terminal that outputs the reset signal 505 as an open collector output according to the state of the power 402 to be monitored. In a case where the voltage value of the divided power 402a is equal to or greater than the predetermined value, the reset signal 505 is pulled up to a high level by the power 402 via the resistor 506. In a case where the voltage value of the divided power 402a is less than the specified value, the reset signal 505 becomes low level. The reset signal 505 is input to the image processor 207. An operation of the image processor 207 is reset by inputting the reset signal 505 at low level. The CD terminal is a terminal for specifying a delay time of the reset signal 505, and is not used in the at least one embodiment.

The configuration of the terminals of the semiconductor device 501 in FIG. 5B is the same as that in FIG. 5A. In FIG. 5B, a manual reset function is achiever by adding a switch circuit 508 to the configuration shown in FIG. 5A. The switch circuit 508 of the at least one embodiment includes a bipolar transistor and two resistor elements. The bipolar transistor has a collector terminal, a base terminal, and an emitter terminal. The collector terminal is connected to the VSEN terminal, the base terminal is connected to the CPU 203 via the first resistor element, and the emitter terminal is grounded. The base terminal and the emitter terminal are connected via a second resistor element. An open collector signal 510 is input to the VSEN terminal from the collector terminal of the switch circuit 508.

The CPU 203 inputs a manual reset signal 509 to the switch circuit 508. The switch circuit 508 inputs the open collector signal 510 corresponding to the manual reset signal 509 to the VSEN terminal. For example, in a case where the manual reset signal 509 is at a low level (i.e., a voltage value close to ground potential), the collector terminal of the impedance of the switch circuit 508 becomes high. In other words, the transistor turns off, and the resistance between the collector terminal and the emitter terminal becomes large. In this case, the reset signal 505 is output from the VOUT terminal according to the state of the power 402 to be monitored. In a case where the manual reset signal 509 is at a high level (i.e., a voltage value close to the power supply potential), the transistor turns on. Since the resistance between the collector terminal and the emitter terminal becomes very small, the collector terminal of the switch circuit 508 is forcibly set to a low level (ground potential) regardless of the power 402 to be monitored. This is because the low-level reset signal 505 is output from the VOUT terminal to indicate that the voltage value of the power 402a has fallen below the predetermined value. Thus, the operation of the image processor 207 is reset. In other words, the semiconductor device 501 resets the image processor 207 in response to receiving the reset signal.

As described above, in the at least one embodiment, the manual reset signal 509 is input, via a switch circuit 508, to the monitor terminal (VSE terminal) for monitoring the voltage of the connected nodes. The VSEN terminal also serves as a reset terminal that receives the manual reset signal 509. Therefore, the semiconductor device can be reset with a simple circuit configuration. As shown in the above relationship between input and output, the switch circuit 508 is an inverting amplifier circuit composed of transistors.

### Another Example of Semiconductor Device for Power Supply Monitoring Device Without Manual Reset Function

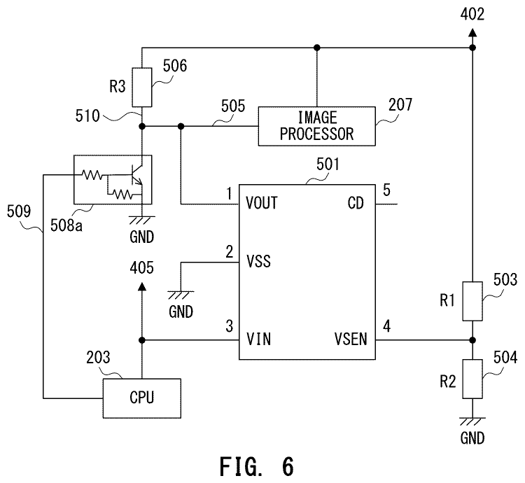

FIG. 6 is an explanatory diagram of another example of a semiconductor device for a power supply monitoring device without a manual reset function. In FIG. 6, a manual reset function is achieved by adding a switch circuit 508a to the configuration of FIG. 5A. The switch circuit 508a has the same configuration as the switch circuit 508 in FIG. 5B, but is provided at a different position in the configuration of the terminals shown in FIG. 5B. The switch circuit 508a has a collector terminal connected to the VOUT terminal, a base terminal connected to the CPU 203 via a resistor, and an emitter terminal connected to ground. The base terminal and the emitter terminal are connected via a resistor.

The CPU 203 inputs a manual reset signal 509 to the switch circuit 508. The switch circuit 508a controls the reset signal 505 output from the VOUT terminal according to the value of the manual reset signal 509. For example, in a case where the manual reset signal 509 is at a high level, the switch circuit 508 forcibly sets the reset signal 505 to a low level. In a case where the manual reset signal 509 is at a low level, the reset signal 505 is maintained in a state corresponding to the state of the power 402 to be monitored output from the VOUT terminal. Thus, in the at least one embodiment, the reset signal 505 is controlled by the manual reset signal 509 via the switch circuit 508a. Therefore, the semiconductor device can be reset with a simple circuit configuration.

As described in FIG. 5B and FIG. 6, though the semiconductor device 501 has no manual reset function, it is possible to add a manual reset function by adding peripheral components. Thus, even if it is difficult to procure the semiconductor device 401 having a manual reset function for a power supply monitoring device, it is possible to continue manufacturing of the circuit board by using the semiconductor device 501 as a substitute component and employing a configuration as shown in FIG. 5B or FIG. 6.

### Embedding State

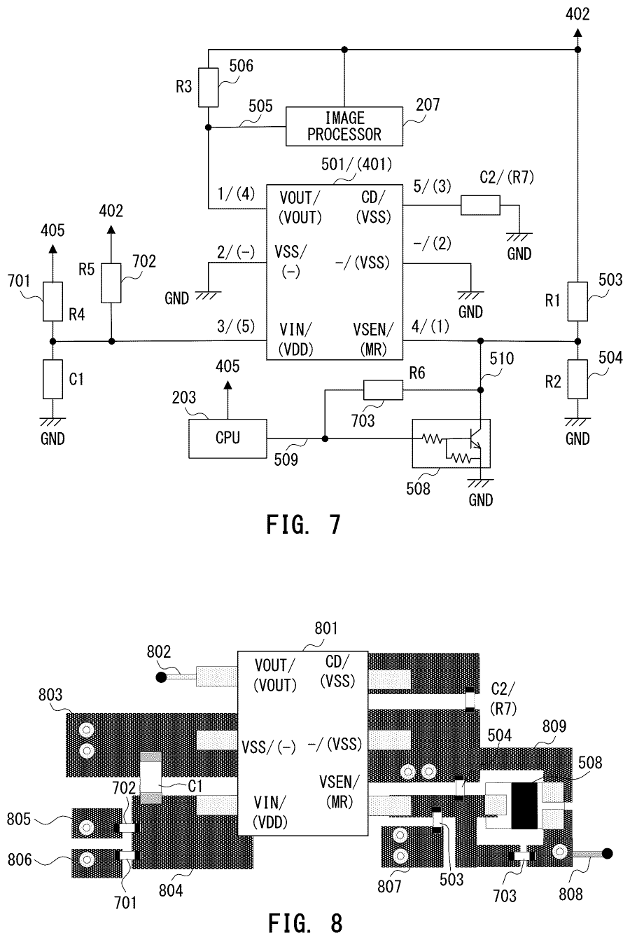

FIG. 7 is an explanatory diagram of a circuit board on which semiconductor devices for multiple types of power supply monitoring devices are mountable. Hereinafter, a circuit board on which the semiconductor device 401 having the manual reset function and the semiconductor device 501 not having the manual reset function are selectively switched and mounted will be described. In the layout shown in FIG. 7, the semiconductor device 401 and the semiconductor device 501 are arranged in a state rotated 180 degrees relative to each other. By mounting the semiconductor device 401 and the semiconductor device 501 rotated 180 degrees relative to each other, as to the terminals of the semiconductor device 401 and the semiconductor device 501 that are assigned the same functions, they are arranged in the same positions. The configuration shown in FIG. 5B is used for the peripheral components of the semiconductor device 501. In FIG. 7, the pin arrangement without parentheses indicates the pin arrangement of the semiconductor device 501, and the pin arrangement with parentheses indicates the pin arrangement of the semiconductor device 401.

When mounting the semiconductor device 501, the VOUT terminal and the VSS terminal are used in common with the semiconductor device 401. The VOUT terminal outputs the reset signal 505. The VSS terminal is grounded. The VIN terminal of the semiconductor device 501 is connected to a short resistor 701 for supplying the power 405. In a case where the semiconductor device 501 is mounted, the short resistor 702 for supplying power 402 is not mounted.

As in the configuration shown in FIG. 5B, the VSEN terminal of the semiconductor device 501 is connected to the resistors 503 and 504 for monitoring the state of the power 402 to be monitored, and to the switch circuit 508 for adding the manual reset function. In a case where the semiconductor device 501 is mounted, the short resistor 703 is not mounted. The CD terminal of the semiconductor device 501 is connected to a capacitor C2 as necessary, and is not connected to anything when not needed.

In a case where the semiconductor device 401 is mounted, a short resistor 702 for supplying the power 402 to be monitored is connected to the VDD terminal. In a case where the semiconductor device 401 is mounted, the short resistor 701 is not mounted. The MR terminal of the semiconductor device 401 is connected to a short resistor 703, and a manual reset signal 509 is input through the short resistor 703. In a case where the semiconductor device 401 is mounted, the switch circuit 508, resistor 503, and resistor 504 are also not mounted. The VSS terminal of the semiconductor device 401 is grounded through a short resistor R7.

FIG. 8 is an explanatory diagram of a wiring pattern of the circuit board shared by the semiconductor device 401 and the semiconductor device 501. FIG. 8 shows the wiring pattern of the circuit configuration shown in FIG. 7.

The semiconductor device 401 and the semiconductor device 501 are exclusively mounted in the same region, i.e., a mounting region 801. The VOUT terminal of the semiconductor device 401 and the semiconductor device 501 is connected to a reset signal pattern 802 which outputs a reset signal. The VSS terminal of the semiconductor device 501 is connected to a ground pattern 803.

The VIN terminal of the semiconductor device 501 and the VDD terminal of the semiconductor device 401 are connected to a power supply pattern 804 and are supplied with the power from the power supply pattern 804. The power 402 is supplied from a power supply pattern 805 to the power supply pattern 804 via the short resistor 702. The power 405 is supplied from a power supply pattern 806 to the power supply pattern 804 via the short resistor 701. Depending on the semiconductor device to be mounted, one of short resistors 701 and 702 is mounted and the other is not mounted. Specifically, in a case where the semiconductor device 401 is mounted, the short resistor 702 is mounted, and in a case where the semiconductor device 501 is mounted, the short resistor 701 is mounted.

The VSEN terminal of the semiconductor device 501 is connected to a connection point between the resistors 503 and 504. The resistor 503 is connected to a power supply pattern 807 to which the power 402 is supplied, and the resistor 504 is connected to a grounding pattern 809, which is grounded, thus, the power 402 is divided by the resistors 503 and 504 and is input to the VSEN terminal.

The manual reset signal 509 is input from a signal pattern 808. The manual reset signal 509 is input to the semiconductor device 401 or the semiconductor device 501 via the short resistor 703 or the switch circuit 508. In a case where the semiconductor device 401 is mounted, the short resistor 703 is mounted and the switch circuit 508 is not mounted. In a case where the semiconductor device 501 is mounted, the switch circuit 508 is mounted and the short resistor 703 is not mounted.

Thus, in a case where the semiconductor device 501 is mounted, the capacitor C1, the resistors 503, 504, 701, and the switch circuit 508 are mounted to the circuit board, and the short resistors 702 and 703 are not mounted to the circuit board. In a case where the semiconductor device 401 is mounted, the capacitor C1, and the short resistors 702, 703, R7 are mounted to the circuit board, and the resistors 503, 504, 701, and the switch circuit 508 are not mounted to the circuit board.

Thus, even when the semiconductor device 501, which has no manual reset function, is mounted, the manual reset function can be achieved by adding peripheral components. In the at least one embodiment, in a case where the semiconductor device 501 is mounted, a component for inputting the reset signal 505 for forcibly resetting the image processor 207 is provided as the peripheral component. The peripheral components for achieving the manual reset function are not mounted in a case where the semiconductor device 401 having a manual reset function is mounted.

In other words, in a case where the semiconductor device 501, which has no predetermined function, is mounted as a replacement part the semiconductor device 401 having the predetermined function, peripheral components for achieving the predetermined function are mounted on the circuit board. The wiring patterns provided on the circuit board are designed to be compatible with any semiconductor device that may be mounted on the circuit board. Such a circuit board enables continuing stable manufacturing regardless of the procurement status of parts while saving space by switching the parts to be mounted.

According to the at least one embodiment of the present disclosure, an image forming apparatus with a simple configuration can be provided. Further, according to the at least one embodiment of the present disclosure, there is provided an image forming apparatus in which the reduction of the usability is suppressed.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-134365, filed Aug. 9, 2024, which is hereby incorporated by reference herein in its entirety.

What is claimed is:

1. An image forming apparatus, comprising:
a semiconductor device including a monitor terminal configured to monitor a voltage of a connected node which is connected to the monitor terminal;
an image forming unit configured to form an image on a recording medium based on image data; and
a controller configured to control the semiconductor device and the image forming unit,
wherein the controller is configured to transmit a reset signal for resetting the semiconductor device to the semiconductor device.

2. The image forming apparatus according to claim 1, further comprising a switch circuit configured to control the voltage of the connected node based on the reset signal.

3. The image forming apparatus according to claim 2,
wherein the switch circuit includes an inverting amplifier circuit including at least one transistor.

4. The image forming apparatus according to claim 1,
wherein the semiconductor device further includes a reset terminal configured to receive the reset signal.

5. The image forming apparatus according to claim 1, further comprising an image processor configured to process the image data,
wherein the semiconductor device is configured to monitor a power supply which is supplied to the image processor and to reset the image processor based on the monitoring of the power supply, and
wherein the controller is configured to transmit the reset signal to the semiconductor device based on a result of monitoring the image processor; and
wherein the semiconductor device is configured to reset the image processor in response to receiving the reset signal.
